(19) United States
(12) Patent Application Publication
(10) Pub. No.: US 2025/0231397 A1
(43) Pub. Date: Jul. 17, 2025

(54) OPTICAL ROTATOR SYSTEMS AND METHODS

(71) Applicant: THE BOARD OF REGENTS OF THE UNIVERSITY OF TEXAS SYSTEM, Austin, TX (US)

(72) Inventors: Bingying CHEN, Dallas, TX (US); Bo-Jui CHANG, Dallas, TX (US); Reto Paul FIOLKA, Dallas, TX (US)

(73) Assignee: THE BOARD OF REGENTS OF THE UNIVERSITY OF TEXAS SYSTEM, Austin, TX (US)

(21) Appl. No.: 18/697,643

(22) PCT Filed: Oct. 6, 2022
(86) PCT No.: PCT/US2022/077658

§ 371 Date: Apr. 1, 2024

Related U.S. Application Data
(60) Provisional application No. 63/253,047, filed on Oct. 6, 2021.

(51) Int. Cl. G02B 26/08

(52) U.S. Cl. CPC G02B 26/0816

(57) ABSTRACT

Systems and methods to rotate a beam of light in an optical system include a first mirror galvanometer, a second mirror galvanometer, and a plurality of static mirrors. The first mirror galvanometer and the second mirror galvanometer are movable between different indexed mirror tilt angles. The different indexed mirror tilt angles cause an input beam of light to be reflected to and from different static mirrors of the plurality of static mirrors (e.g., which can be vertically stacked). A plurality of indexed mirror tilt angles rotate an input beam of light a plurality of indexed rotation angles by directing a reflected beam of light to and from the static mirror(s). Switching between indexed rotation angles can include an angle transition period of less than 50 milliseconds. The rotated beam of light is received at a microscope viewing device or at a sample being illuminated by the rotated beam of light.

### CROSS REFERENCE TO RELATED APPLICATION

This application claims the benefit of U.S. Provisional Patent Application No. 63/253,047, filed Oct. 6, 2021, the content of which is incorporated by reference in its entirety.

### ACKNOWLEDGEMENT OF GOVERNMENT SUPPORT

This invention was made with government support under grant number GM133522 awarded by The National Institutes of Health. The government has certain rights in the invention.

### BACKGROUND

### 1. Field

The present disclosure relates generally to systems and methods for rotating a beam of light in an optical system. In at least one example, the present disclosure relates to a system configured to rotate a beam of light using mirror galvanometers and static mirrors to form a rotation angle.

### 2. Discussion of Related Art

Conventional optical systems mechanically rotate images using a dovetail prism, Abbe-Koenig prism, or K-mirror system inserted into the optical path of an imaging system. These techniques include mounting the prisms or the entire K-mirror system onto a rotation stage. Accordingly, the ability to rotate the image is tied to the rotation speed and characteristics of the rotation stage. However, rotation stages typically rotate slowly, taking hundreds of milliseconds or even seconds to complete a rotation. The slow rotation speed of the rotation stage constrains the pace of data collection, limiting the capacity to quickly view or combine images from multiple angles.

Moreover, beams of light rotated using prisms on rotation stages lose resolution quality due to distortions caused by the light passing through the prisms and produce aberrations, such as astigmatism, when used with converging light. To overcome the speed limitations, some imaging systems split the incident beam into multiple beamlets which are then rotated. Rotating individual beamlets is done one at a time by mechanically flipping mirrors, which is slow, or using polarization optics, which is not suitable for unpolarized light. These types of systems are overly complex, slow, and not useful for multiple, different applications.

It is with these observations in mind, among others, that various aspects of the present disclosure were conceived and developed.

### BRIEF SUMMARY

The presently disclosed technology addresses the foregoing problems by providing systems and methods for rotating a beam of light. In some examples, a method to rotate a beam of light comprises: reflecting an input beam of light at a first reflection angle using a first mirror galvanometer, the first reflection angle determined by a mirror tilt angle of the first mirror galvanometer, the first mirror galvanometer directing the input beam of light to a static mirror of a plurality of static mirrors as a first reflected beam; reflecting the first reflected beam with the static mirror to direct the first reflected beam to a second mirror galvanometer as a second reflected beam; and reflecting the second reflected beam at a second reflection angle using the second mirror galvanometer, the second reflection angle determined by the mirror tilt angle of the second mirror galvanometer, the second mirror galvanometer forming a rotated beam of light having a rotation angle, relative to the input beam of light, corresponding to the mirror tilt angle.

In some examples, the static mirror is a first static mirror of the plurality of static mirrors; the mirror tilt angle is a first mirror tilt angle; the rotation angle is a first rotation angle; and the method further includes: moving the first mirror galvanometer and the second mirror galvanometer to a second mirror tilt angle; directing the first reflected beam from the first mirror galvanometer to a second static mirror of the plurality of static mirrors; and directing the second reflected beam from the second static mirror to the second mirror galvanometer, the rotated beam of light having a second rotation angle, relative to the input beam of light, corresponding to the second mirror tilt angle. The second static mirror can be positioned above the first static mirror; and the method can further include: moving the first mirror galvanometer and the second mirror galvanometer to a third mirror tilt angle; directing the first reflected beam from the first mirror galvanometer to a third static mirror of the plurality of static mirrors, the third static mirror positioned below the first static mirror; and directing the second reflected beam from the third static mirror to the second mirror galvanometer, the rotated beam of light having a third rotation angle, relative to the input beam of light, corresponding to the third mirror tilt angle, the third rotation angle being an inverse of the second rotation angle. Furthermore, moving the first mirror galvanometer and the second mirror galvanometer to the second mirror tilt angle or the third mirror tilt angle can include an angle transition period of between 1 millisecond and 50 milliseconds.

In some instances, the first mirror galvanometer, the second mirror galvanometer, and the first static mirror are in a mirror galvanometer plane. The first static mirror can be positioned parallel to a y-z plane. The second static mirror and the third static mirror can be positioned outside the mirror galvanometer plane. Moreover, the method can include directing the input beam of light from a light source to the first mirror galvanometer using a static image input mirror; and directing the rotated beam of light from the second mirror galvanometer to a microscope viewing device using a static image output mirror. The light source can be a light sheet fluorescence image, a structured illumination microscopy image, or an illumination light for light-sheet fluorescence or structured illumination microscopy. Moreover, the mirror tilt angle can be selectable between a plurality of indexed mirror tilt angles causing the rotation angle to be selectable between a plurality of indexed rotation angles. The plurality of indexed mirror tilt angles can include: a neutral angle; a positive angle relative to the neutral angle; and a negative angle relative to the neutral angle. The rotation angle can be based on: a counter-clockwise rotation corresponding to the positive angle; or a clockwise rotation corresponding to the negative angle. Additionally, the plurality of indexed rotation angles can include a 45-degree angle, a 60-degree angle, a 120-degree angle, and a 180-degree angle.

In some examples, an imaging system for rotating a beam of light comprises: a first mirror galvanometer positioned to reflect an input image beam at a plurality of first indexed reflection angles determined by a mirror tilt angle of the first mirror galvanometer as a first reflected image beam; a plurality of static mirrors positioned to reflect the first reflected image beam, as a second reflected image beam, at different reflection angles corresponding to the plurality of first indexed reflection angles; and a second mirror galvanometer positioned to reflect the second reflected image beam at a plurality of second indexed reflection angles determined by the mirror tilt angle of the second mirror galvanometer, the second mirror galvanometer forming a rotated image beam having a rotation angle, relative to the input image beam, corresponding to the mirror tilt angle. The plurality of static mirrors can be positioned between the first mirror galvanometer and the second mirror galvanometer along an x-axis; and the plurality of static mirrors can be positioned spaced a distance apart from the first mirror galvanometer and the second mirror galvanometer along a z-axis.

In some instances, the plurality of static mirrors include: a first static mirror positioned at a mirror galvanometer plane; a second static mirror positioned above the mirror galvanometer plane; and a third static mirror is positioned below the mirror galvanometer plane. The mirror tilt angle can be a first mirror tilt angle; and the imaging system can include a memory device storing instructions that, when executed by a processor, cause the imaging system to: move the first mirror galvanometer and the second mirror galvanometer from the first mirror tilt angle to a second mirror tilt angle such that the first reflected image beam is shifted from reflecting off a first static mirror of the plurality of static mirrors to a reflecting off a second static mirror of the plurality of static mirrors. Furthermore, the instructions, when executed by the processor, can cause the imaging system to move the first mirror galvanometer and the second mirror galvanometer from the first mirror tilt angle to the second mirror tilt angle in an angle transition period in a range of between 1 and 50 milliseconds.

In some examples, a method to rotate a beam of light comprises: reflecting an input image beam at a first indexed reflection angle of a plurality of indexed reflection angles using a first mirror galvanometer, the plurality of indexed reflection angles determined by a mirror tilt angle of the first mirror galvanometer, the first mirror galvanometer directing the input image beam to a static mirror of a plurality of static mirrors as a first reflected image beam; reflecting the first reflected image beam with the static mirror to direct the first reflected image beam to a second mirror galvanometer as a second reflected image beam; and reflecting the second reflected image beam at a second indexed reflection angle of a the plurality of indexed reflection angles using the second mirror galvanometer, the second indexed reflection angle determined by the mirror tilt angle of the second mirror galvanometer, the second mirror galvanometer forming a rotated image beam having a rotation angle, relative to the input image beam, corresponding to the mirror tilt angle. Additionally, the plurality of indexed reflection angles can correspond to a plurality of indexed rotation angles of the rotated image beam.

The foregoing is intended to be illustrative and is not meant in a limiting sense. Many features of the embodiments may be employed with or without reference to other features of any of the embodiments. Additional aspects, advantages, and/or utilities of the presently disclosed technology will be set forth in part in the description that follows and, in part, will be apparent from the description, or may be learned by practice of the presently disclosed technology.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate an implementation of systems and methods consistent with the disclosed subject matter and, together with the description, serves to explain advantages and principles consistent with the disclosed subject matter, in which:

FIGS. 1A and 1B illustrate an example optical system for rotating a beam of light;

FIG. 2 illustrates an example optical system for rotating a beam of light, which can form at least a portion of the optical system of FIGS. 1A and 1B;

FIG. 3 illustrates an example optical system for rotating a beam of light, which can form at least a portion of the optical system of FIGS. 1A and 1B;

FIG. 4A illustrates an example diagram of an example optical system depicting angles and analytical calculations for rotating a beam of light, which can form at least a portion of the optical system of FIGS. 1A and 1B;

FIG. 4B illustrates an example relative rotation angle versus scanning angle graph, which can represent at least a portion of the optical system of FIGS. 1A and 1B;

FIG. 5 illustrates an example computing architecture for rotating a beam of light which can form at least a portion of the optical system of FIGS. 1A and 1B; and

FIG. 6 illustrates an example method for rotating a beam of light, which can be performed by the optical system of FIGS. 1A and 1B.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

### I. Terminology

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the presently disclosed technology or the appended claims. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to embodiments of many different forms, it is intended that the present disclosure be considered as an example of the principles of the presently disclosed technology and not intended to limit the presently disclosed technology to the specific embodiments shown and described. Any one of the features of the presently disclosed technology may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the presently disclosed technology may include a variety of combinations and/or integrations of the embodiments described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described. The term “real-time” or “real time” means substantially instantaneously.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

### II. General Architecture

The systems disclosed herein improve upon previous techniques by rotating a beam of light using a first mirror galvanometer, a second mirror galvanometer, and a plurality of static mirrors. The first mirror galvanometer and the second mirror galvanometer are movable between a plurality of indexed mirror tilt angles that cause the beam of light to be rotated a plurality of indexed rotation angles. The systems avoid using prisms or K-mirrors and, accordingly, do not rely on a mechanical rotation stage for creating beam and/or image rotations. Rather, the systems disclosed herein use mirror galvanometers that can be rapidly changed between different indexed mirror tilt angles to quickly rotate the beam of light, for instance, within a few milliseconds. The system creates a discrete number of rotations with magnitudes that can be intentionally selected. For instance, the plurality of static mirrors includes one mirror for each desired rotation angle so that the number of static mirrors corresponds to the number of desired rotation angles. As such, the particular rotation angles and number of rotation angles can be changed to fit the needs of various different applications. The system can cause light reflecting or fluorescing from a sample to be rotated and viewed at a microscope viewing device in the rotated form. Moreover, in some applications, the system can cause an illumination beam of light (e.g., a laser beam, a plurality of laser beams, a light sheet, etc.) to be rotated as it is transmitted to the sample. As such, the system can rotate a beam of light going to or from the sample.

The plurality of static mirrors are arranged to reflect the beam of light from the first mirror galvanometer to the second mirror galvanometer. For instance, an input beam of light is reflected from the first mirror galvanometer to a first static mirror of the plurality of static mirrors as a first reflected beam. The first reflected beam strikes the first static mirror due to a first mirror tilt angle of the first mirror galvanometer. When the first mirror galvanometer is moved from the first indexed mirror tilt angle to a second indexed mirror tilt angle, the first reflected beam strikes a second static mirror (e.g., positioned above or below the first static mirror). As the mirror galvanometers are moved between different indexed mirror tilt angles, the beam of light is directed to different static mirrors of the plurality of static mirrors. The first reflected beam is ultimately reflected back to the second mirror galvanometer from one of the plurality of the static mirrors, and the second mirror galvanometer outputs the rotated beam of light. The rotated beam of light has a rotation angle corresponding to the mirror tilt angle of the first mirror galvanometer and the second mirror galvanometer. The symmetry and structure of the system maintains the collinearity of the output light under different rotation angles. The odd number of mirrors can also flip the image.

The different indexed mirror tilt angles cause the input beam of light to be rotated with indexed rotation angles. A computing device can be programmed to store a plurality of indexed mirror tilt angle values and/or a plurality of indexed image rotation angle values that can be quickly retrieved and executed (e.g., by a systems controller) to create the indexed rotation angles. Accordingly, the system can cause the beam of light to be rotated quickly with an angle transition period orders of magnitude faster than typical systems. For instance, the system can transition between different predetermined rotation angles in a few milliseconds, 10 milliseconds, or between one and 50 milliseconds, and is only limited by the scanning speed of the mirror galvanometers (or other scanning device). In contrast, prisms or K-mirror system mounted to rotation stages typically take 100-1000 milliseconds to complete a rotation. Moreover, the rotated beam of light, which can contain an image for viewing (e.g., an image beam), has high resolution because the beam of light or image beam is rotated without passing through any prisms. The systems disclosed herein are equally effective for both polarized and unpolarized light.

Additional advantages of the systems discussed herein will become apparent from the detailed description below.

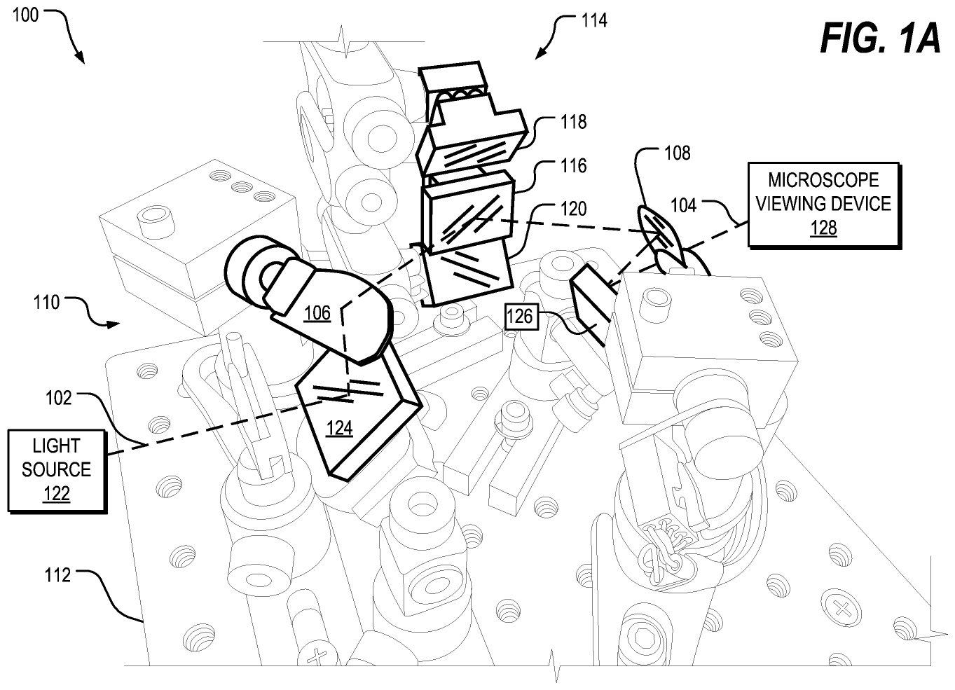

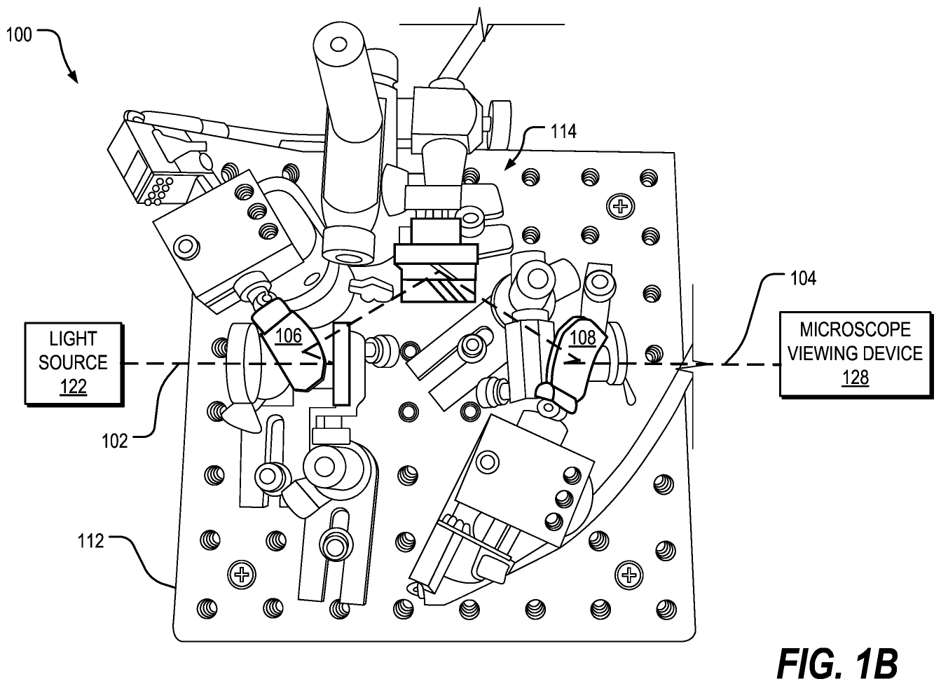

FIG. 1 illustrates an example optical system 100 for rotating a beam of light. The optical system 100 can receive an input beam of light 102 and, through a unique arrangement of angled reflections using mirror galvanometers and static mirrors, transforms the input beam of light 102 into a rotated image beam 104 with a rotation angle corresponding to a mirror tilt angle of the mirror galvanometers.

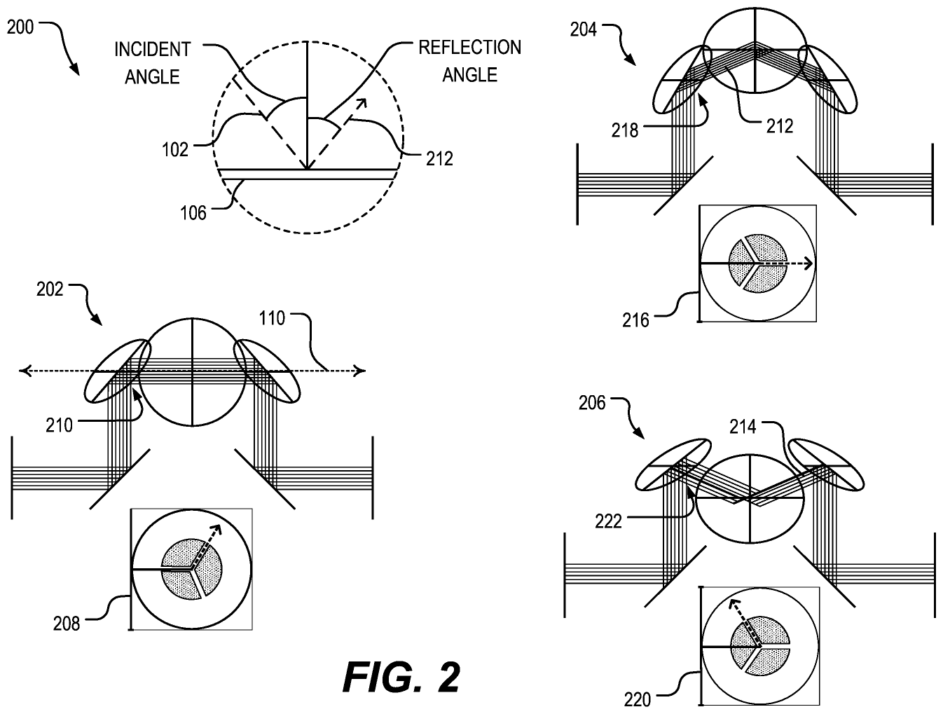

For instance, the optical system 100 can include a first mirror galvanometer 106 and a second mirror galvanometer 108 that are movable between a plurality of mirror tilt angles, such as indexed mirror tilt angles (as discussed in greater detail below regarding FIGS. 2-4). The first mirror galvanometer 106 and the second mirror galvanometer 108 can define or be in a mirror galvanometer plane 110. The mirror galvanometer plane 110 can be a substantially horizontal plane and/or be substantially parallel to a mounting surface 112 for the mirror galvanometers and the static mirrors or the ground. One or more of the mirror galvanometers discussed herein (e.g., the first mirror galvanometer 106, the second mirror galvanometer 108, etc.) can be a current sensing device that rotates a mirror (e.g., or a post to which the mirror is mounted) an angle (e.g., which can be a component of a “mirror tilt angle”) corresponding to a magnitude and direction of the electric current.

In some instances, a plurality of static mirrors 114 can be positioned between the first mirror galvanometer 106 and the second mirror galvanometer 108 (e.g., with respect to a z-axis direction). The plurality of static mirrors 114 can include a first static mirror 116 arranged in and/or aligned with the mirror galvanometer plane 110. The plurality of static mirrors 114 can include a second static mirror 118 positioned above the first static mirror 116 and/or above the mirror galvanometer plane 110. Additionally, the plurality of static mirrors 114 can include a third static mirror 120 positioned below the first static mirror 116 and/or below the mirror galvanometer plane 110. The plurality of static mirrors 114 can be stacked substantially vertically and with non-parallel mirror surfaces. Moreover, the different static mirrors of the plurality of static mirrors 114 can have different fixed angles for reflecting a beam from the first mirror galvanometer 106 to the second mirror galvanometer 108. For instance, the first static mirror 116 can have a fixed angle substantially perpendicular to the mirror galvanometer plane 110, such that the first static mirror 116 is aligned substantially vertically or perpendicular to the ground. A first reflected beam directed at the first static mirror 116 from the first mirror galvanometer 106 is reflected from the first static mirror 116 to the second mirror galvanometer 108 as a second reflected beam. Similarly the second static mirror 118 can have a fixed angle such that the second static mirror 118 is angled toward the mirror galvanometer plane 110 (e.g., in a downward direction), and the third static mirror 120 can have a fixed angle such that the third static mirror 120 is angled toward the mirror galvanometer plane 110 (e.g., in an upward direction). Techniques for using the plurality of static mirrors 114 to reflect the first reflected image beam from the first mirror galvanometer 106 to the second mirror galvanometer 108 (e.g., as the second reflected image beam) are discussed in greater detail below.

In some examples, the optical system 100 can receive the input beam of light 102 from a light source 122. The versatility of the system 100 means a wide variety of scanning techniques may be used with the system 100. For instance, light source 122 can be a sample or illumination light for structured illumination microscopy (SIM), oblique plane microscopy (OPM), light-sheet fluorescence microscopy (LSFM), swept confocally aligned planar excitation (SCAPE) microscopy, kHZ two-photon scanned line angular projection (SLAP) microscopy, or the like. When the light source 122 is a sample, the input beam of light 102 can be an image beam including an image corresponding to the sample. For structured illumination microscopy and kHz two-photon tomography, introduction of the system 100 can provide implementations that are less complex and more compact for rotating images than previous techniques. For structured illumination, the system 100 can rotate the beam of light in three angular steps of 60 degrees. For SLAP systems, the system 100 can rotate the beam of light in four angular steps with 45 degrees between each step. For some systems (e.g., OPM, SCAPE, LSFM, etc.), the lights source 122 can be illumination light (e.g., a laser beam or a plurality of laser beams) for transmitting onto a sample, and the system 100 can rotate the illumination light which provides illumination and viewing of the sample from multiple angles, further enabling image fusion from multiple angles and improving image clarity on complex samples. Furthermore, the system 100 can make combining an OPM system with a SCAPE system with structured illumination microscopy possible. The system can improve the clarity of an OPM system or a SCAPE system by being set up to rotate the image in one step by 180 degrees or in two steps by 120 degrees for each step.

The beam of light and/or an image beam reflecting off or originating from the light source 122 can be directed to a static or adjustable input mirror 124. The static or adjustable input mirror 124 can be adjustable to align or redirect the light from the light source 122 toward the first mirror galvanometer 106 as the input beam of light 102 (e.g., at a 45-degree incident angle with the first mirror galvanometer 106). Moreover, the optical system 100 can include a static or adjustable output mirror 126. The static or adjustable output mirror 126 can reflect the rotated image beam 104 from the second mirror galvanometer 108 toward a microscope viewing device 128 (e.g., a camera, an eye piece, an oblique plane microscope or viewing lens, a SIM system, and OPM system, a SCAPE system, a SLAP system, or the like) and/or to a sample to be illuminated by the rotated beam of light 104.

The optical system 100 can be formed of various optical system equipment. For instance, the first mirror galvanometer 106 and/or second mirror galvanometer 108 can include any type of mirror galvanometer (e.g., similar or identical to those manufactured by Thorlabs, Cambridge technologies and others), such as a 1-axis, 2-axis, or 3-axis mirror galvanometer having an input beam diameter range of between about 5 millimeters (mm) to about 45 mm and/or having one or mirror coatings. Additionally or alternatively, the mirror galvanometers discussed herein may be galvanometer optical scanners or any other type of beam scanning/reflecting device. The mounting surface 112 can be a top surface of an optical table and/or a breadboard plate (e.g., mountable to the optical table). In some instances, the optical system 100 (e.g., and/or the optical system 200 discussed below) is an integrated optical lab subsystem.

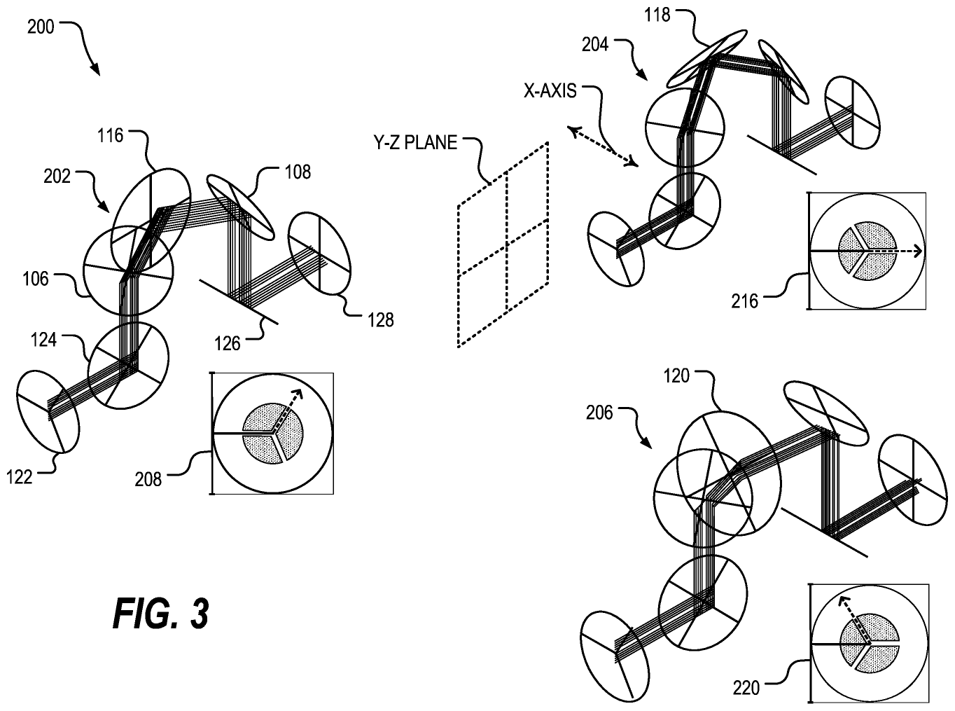

FIGS. 2 and 3 illustrate an optical system 200 for generating the rotated beam of light 104 from the input beam of light 102 using the first mirror galvanometer 106, the second mirror galvanometer 108, and the plurality of static mirrors 114. FIGS. 2 and 3 are based on Zemax simulations showing the first mirror galvanometer 106 and the second mirror galvanometer 108 rotating at −10, 0, and 10 degrees.

The optical system 200 depicted in FIGS. 2 and 3 can form at least a portion of and/or be identical to the optical system 100. The optical system 200 can be adjustable between a plurality of indexed mirror tilt angles such as a first mirror tilt angle 202, a second mirror tilt angle 204, and a third mirror tilt angle 206. FIG. 2 depicts front elevation views of the optical system 200 in three configurations corresponding to these three mirror tilt angles. FIG. 3 depicts perspective views of the optical system 200 in the three configurations.

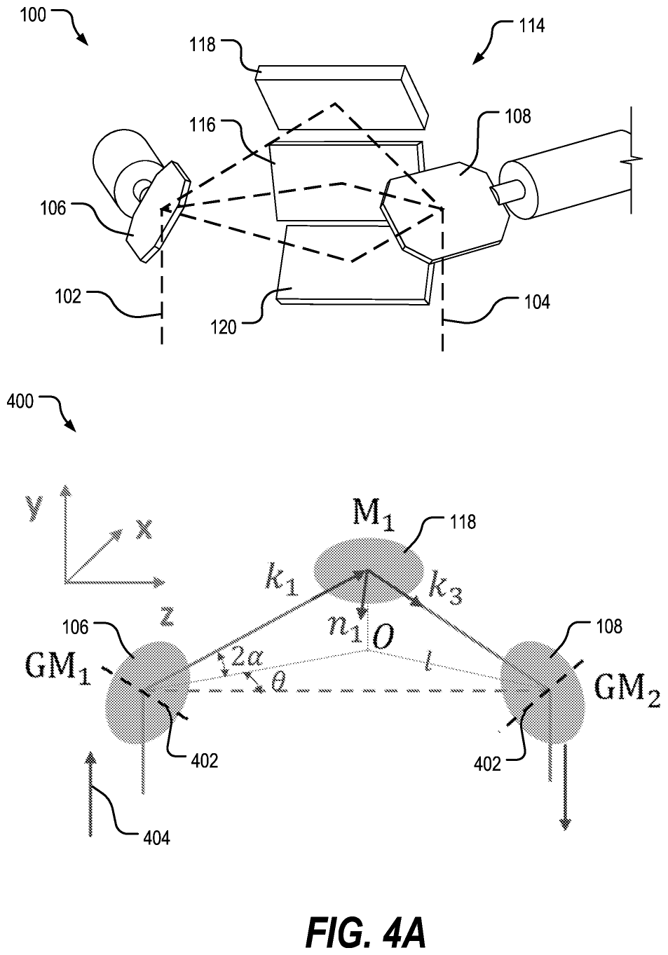

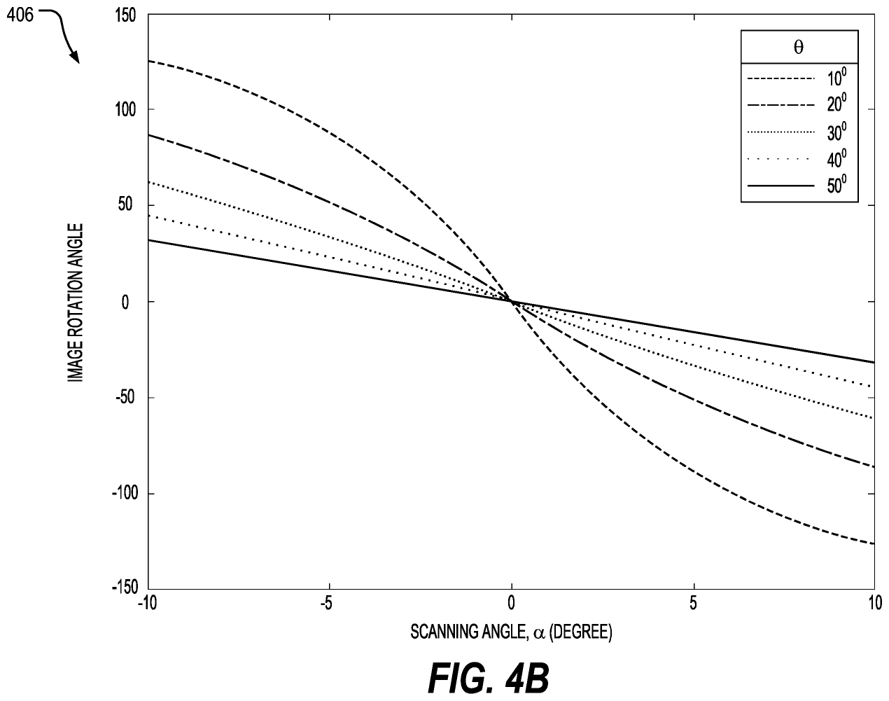

In some examples, the first mirror galvanometer 106 and the second mirror galvanometer 108 can have the first mirror tilt angle 202 and the rotated beam of light 104 can have a first rotation angle 208 corresponding to the first mirror tilt angle 202. The first mirror tilt angle 202 can cause the first mirror galvanometer 106 to reflect the input beam of light 102 (e.g., from the static or adjustable input mirror 124) as a first reflected beam 212 directed to the first static mirror 116. A first reflection angle 210 of the first mirror galvanometer 106 can be 45 degrees, for instance, caused by the first mirror tilt angle 202 being 135 degrees with respect to the mirror galvanometer plane 110 (e.g., or 45 degrees depending on the selected normal line for calculating the angle) and the input beam of light 102 being vertically aligned (e.g., perpendicular to a ground/horizontal plane) with a 45-degree incidence angle at the first mirror galvanometer 106. With the first mirror tilt angle 202 configuration, the first mirror galvanometer 106 can reflect the first reflected beam 212 in and/or parallel to the mirror galvanometer plane 110 towards the first static mirror 116, which is also in the mirror galvanometer plane 110. The first static mirror 116 reflects the first reflected beam 212 as a second reflected beam 214 toward the second mirror galvanometer 108. In the first mirror tilt angle 202 configuration, the second reflected beam 214 also stays in the mirror galvanometer plane 110 and forms an incidence angle with the second mirror galvanometer 108 that can be 45 degrees. It is to be understood, however, that in some examples, such as the configuration depicted in FIG. 4A, the coordinate system of measurement can be rotated for discussion purposes, such that the 45 degree first mirror tilt angle 202 can be defined as a zero or neutral mirror tilt angle, and additional mirror tilt angles (e.g., the second mirror tilt angle 204, the third mirror tilt angle 206, etc.) can be defined as positive or negative relative to the neutral or zero first mirror tilt angle 202.

The second mirror galvanometer 108 can have the same first mirror tilt angle 202 as the first mirror galvanometer 106. For instance, the second mirror galvanometer 108 can form a 45-degree angle (e.g., or a 135-degree angle, or a zero or neutral angle depending on the selected coordinate system or normal line) with the mirror galvanometer plane 110. Additionally, the first static mirror 116 can be spaced a distance apart from the first mirror galvanometer 106 and the second mirror galvanometer 108 in a x-axis direction so that the first mirror tilt angle 202 also includes a component in the x-axis direction (e.g., the angle ±θ which can be a distancing angle, as discussed in greater detail below regarding FIG. 4A) to direct the first reflected beam 212 and the second reflected beam 214 away from the y-z plane. The second mirror galvanometer 108 can reflect the second reflected beam 214 as the rotated beam of light 104 (e.g., towards the static or adjustable output mirror 126) with a 45-degree reflection angle, such that the rotated beam of light 104 is directed vertically (e.g., perpendicular to the ground/horizontal plane). With the first mirror tilt angle 202, the rotated beam of light 104 can have the first rotation angle 208 of, for instance, about 58 degrees. As noted above, in some instances, the first mirror tilt angle 202 can be categorized, configured, or calibrated as a neutral tilt angle (e.g., based on the first mirror tilt angle 202 being the 45-degree angle and/or directing the first reflected beam parallel to the mirror galvanometer plane 110). In response, the first rotation angle 208 can be categorized, configured, or calibrated as a neutral rotation or an initial rotation corresponding to the neutral tilt angle. The neutral tilt angle and/or neutral rotation can be an initial rotation (e.g. corresponding to using the first static mirror 116) for systems including a plurality of indexed mirror tilt angles corresponding to a plurality of indexed rotation angles.

In some examples, the first mirror galvanometer 106 and the second mirror galvanometer 108 can have the second mirror tilt angle 204 and the rotated beam of light 104 can have a second rotation angle 216 corresponding to the second mirror tilt angle 204. The second mirror tilt angle 204 can cause the first mirror galvanometer 106 to reflect the input beam of light 102 as the first reflected beam 212 at a second reflection angle 218. The second reflection angle 218 can be 20 degrees, for instance, caused by the second mirror tilt angle 204 being +10 degrees from the neutral angle (e.g., or 55 degrees depending on the selected normal line). With the second mirror tilt angle 204, the first mirror galvanometer 106 can reflect the first reflected beam 212 at the second reflection angle 218 with respect to the mirror galvanometer plane 110 such that the first reflected beam 212 is directed out of the mirror galvanometer plane 110 toward the second static mirror 118 above the mirror galvanometer plane 110. The second static mirror 118 reflects the first reflected beam 212 as the second reflected beam 214 toward the second mirror galvanometer 108 and/or back to the mirror galvanometer plane 110. The second mirror tilt angle 204 can cause the rotated beam of light 104 to have the second rotation angle 216, which can be a clockwise rotation relative to the first rotation angle 208. The second rotation angle 216 can be a categorized as a “positive” rotation relative to a neutral rotation (e.g., the first rotation angle 208).

In some examples, the first mirror galvanometer 106 and the second mirror galvanometer 108 can have the third mirror tilt angle 206 and the rotated beam of light 104 can have a third rotation angle 220 corresponding to the third mirror tilt angle 206. The third mirror tilt angle 206 can cause the first mirror galvanometer 106 to reflect the input beam of light 102 as the first reflected beam 212 at a third reflection angle 222. The third reflection angle 222 can be 35 degrees, for instance, caused by the third mirror tilt angle 206 being 145 degrees with respect to the mirror galvanometer plane 110 (e.g., or 35 degrees depending on the selected normal line) and the input beam of light 102 being vertically aligned with a 35-degree incidence angle at the first mirror galvanometer 106. With the third mirror tilt angle 206, the first mirror galvanometer 106 can reflect the first reflected beam 212 at the third reflection angle 222 with respect to the mirror galvanometer plane 110 such that the first reflected beam 212 is directed out of the mirror galvanometer plane 110 toward the third static mirror 120 below the mirror galvanometer plane 110. The third static mirror 120 reflects the first reflected beam 212 as the second reflected beam 214 toward the second mirror galvanometer 108 and/or back to the mirror galvanometer plane 110. In the third mirror tilt angle 206 configuration, the second reflected beam 214 forms an incident angle with the second mirror galvanometer 108 that can be 35 degrees, and the second mirror galvanometer 108 can reflect the second reflected beam 214 as the rotated beam of light 104 with a 35-degree reflection angle. The third mirror tilt angle 206 can cause the rotated beam of light 104 to have the third rotation angle 220, which can be a counterclockwise rotation relative to the first rotation angle 208. The third rotation angle 220 can be categorized as a “negative” rotation relative to the neutral rotation (e.g., the first rotation angle 208).

Although the second mirror tilt angle 204 is depicted as −10 degrees (e.g., 125 degrees) relative to the first mirror tilt angle 202; and the third mirror tilt angle 206 is depicted as +10 degrees (e.g., 145 degrees) relative to the first mirror tilt angle 202, it is to be understood that other mirror tilt angle increments are within the scope of this disclosure. For instance, the various mirror tilt angles may include increments of 1-degree, 2-degree, 3-degree, 4-degree, 5-degree, etc., which can correspond to various static mirrors aligned for the different mirror tilt angles. In some instances, to generate the rotation angles, the second mirror tilt angle 204 is between a 134-degree angle and 115-degree angle relative to the mirror galvanometer plane 110 (or between −1 and −10 in systems where the first mirror tilt angle 202 is the neutral or zero angle), and the third mirror tilt angle 206 is between a 136-degree angle and a 155-degree angle relative to the mirror galvanometer plane 110 (or between +1 and +10 degrees in systems where the first mirror tilt angle 202 is the neutral or zero angle). The mirror tilt angles can be indexed or predetermined mirror tilt angles corresponding to indexed or predetermined rotation angles of the rotated beam of light 104, as discussed in greater detail below.

FIG. 3 illustrates the optical system 200 for generating a plurality of indexed rotation angles for the rotated beam of light 104 using the first mirror galvanometer 106, the second mirror galvanometer 108 and the plurality of static mirrors 114. The plurality of indexed rotation angles correspond to a plurality of indexed mirror tilt angles, including the first mirror tilt angle 202, the second mirror tilt angle 204, and the third mirror tilt angle 206. FIG. 3 depicts perspective views of the optical system 200 in the first mirror tilt angle 202 configuration, the second mirror tilt angle 204 configuration, and the third mirror tilt angle 206 configuration.

In some examples, the first mirror tilt angle 202 can be a first indexed mirror tilt angle. For instance, a computing device (e.g., computer system 502 discussed below regarding FIG. 4) can execute software controlling operation of the optical system 200 such that the first mirror tilt angle 202 is stored at the computing device as a predetermined mirror or preprogrammed tilt angle for the optical system 200. The first rotation angle 208 can be a preprogrammed or predetermined first indexed rotation angle generated by the optical system 200 when the optical system 200 is in the first mirror tilt angle 202 configuration.

The second mirror tilt angle 204 can be a second indexed mirror tilt angle and the second rotation angle 216 can be a second indexed rotation angle generated by the second indexed mirror tilt angle. The third mirror tilt angle 206 can be a third indexed mirror tilt angle and the third rotation angle 220 can be a third indexed rotation angle generated by the third indexed mirror tilt angle. The second mirror tilt angle 204, the third mirror tilt angle 206, and/or the corresponding rotation angles can be programmed into the optical system 200 such that the optical system 200 is selectable or movable between the first rotation angle 208, the second rotation angle 216 and/or the third rotation angle 220 (e.g., by moving between the different mirror tilt angles). The optical system 200 can include any number of indexed mirror tilt angles corresponding to any number of indexed image rotation angles. The plurality of indexed rotation angles can include various combinations of indexed rotation angles, such as a 120-degree indexed rotation angle and a 180-degree indexed rotation angle (e.g., and a 30-degree rotation angle, a 60-degree rotation angle, and/or a 90-degree rotation angle). Moreover, the plurality of static mirrors 114 can include any number of static mirrors corresponding to any number of indexed mirror tilt angles and/or rotation angles (e.g., 1, 2, 3, 4, 5, 6, 7, 8, 9, 10, etc.) at various angle intervals.

In some examples, the optical system 200 can move or transition between different mirror tilt angles to generate the different rotation angles. A computing device (e.g., computing device 502) communicatively coupled to the first mirror galvanometer 106 and the second mirror galvanometer 108 can provide an electrical voltage/current to the first mirror galvanometer 106 and second mirror galvanometer 108 to cause the first mirror galvanometer 106 and second mirror galvanometer 108 to move to or be positioned at the mirror tilt angle. The optical system 200 can receive an instruction (e.g., via a user input and/or via a schedule) to be in a particular mirror tilt configuration (e.g., the first mirror tilt angle 202, the second mirror tilt angle 204, or the third mirror tilt angle 206) and/or to transition from a first mirror tilt configuration to a second mirror tilt configuration. For instance, the optical system 200 can transition from the first mirror tilt angle 202 to the second mirror tilt angle 204; from the first mirror tilt angle 202 to the third mirror tilt angle 206; from the second mirror tilt angle 204 to the first mirror tilt angle 202; from the second mirror tilt angle 204 to the third mirror tilt angle 206; from the third mirror tilt angle 206 to the first mirror tilt angle 202; and/or from the third mirror tilt angle 206 to the second mirror tilt angle 204. In some examples, the optical system 200 can have an angle transition period of time for transitioning between the mirror tilt angles. The angle transition period can be an amount of time less than 20 ms, less than 30 ms, less than 40 ms, less than 50 ms, or less than 100 ms, or in a range of time having a low end of 1, 2, 3, 4, or 5 ms and a high end of 20, 30, 40, 50, 75, or 100 ms. By way of example, the angle transition period can be 50 ms or less or the angle transition period can be between 1 ms and 50 ms. The angle transition period between rotation angles for the optical system 200 can be significantly less than that of conventional techniques which rely on a rotatable station to move a prism or k-mirror system and can take hundreds of milliseconds, or multiple seconds, to transition between different rotation angles.

FIG. 4A illustrates an example diagram 400 of the optical system 100 including various angles and analytical calculations for rotating the input beam of light 102. The three-dimensional mirror transformation matrices and Zemax to analyze and present the working principle of the image rotator and calculate the discrete rotation angles are discussed below.

In some instances, an angle of the image rotation (e.g., the first rotation angle 208, the second rotation angle 216, the third rotation angle 220, etc.) refers to rotation angle relative to the status of the image when the light travels over the center one of the static mirrors.

To simplify the model analysis of the systems 100 and 200, a Galvo pair (e.g., the first mirror galvanometer 106 and the second mirror galvanometer 108) and a static set of mirrors (e.g., the plurality of static mirrors 114) are depicted as represented by matrix formalism, as shown in FIG. 4A and discussed below. For the systems 100 and 200, it can be assumed both galvo mirrors rotate by the same magnitude ±α. FIG. 4A shows that first mirror galvanometer 106 and the second mirror galvanometer 108 rotated relative to the x-axis by ±θ. As such, the angle ±θ can be a distancing angle which determines a distance in the x-axis direction the plurality of static mirrors 114 are spaced from the mirror galvanometers. The first mirror galvanometer 106 and second mirror galvanometer 108 can both rotate by the angle ±α, resulting in a deflection of the light by ±2α. As such, the mirror tilt angles discussed herein (e.g., the first mirror tilt angle 202, the second mirror tilt angle 204, the third mirror tilt angle 206, etc.) can be the angle ±α depicted or be based on the angle ±α (e.g., ±2α).

The rotation axis 402 of Galvo Mirror 1 (GM1) (e.g., first mirror galvanometer 106) can be perpendicular to the plane of incident and emergent rays 404 (e.g., the input beam of light 102). The matrix of GM1 can be obtained by rotating a virtual z mirror (Mz, surface normal parallel to z-axis) around the x-axis for (45°−α) and then around the y-axis for θ. GM1 can be defined as:

$${GM}_{1} = {R}_{y} ( θ ) {R}_{x} ( 45 ° - α ) {M}_{z} {{R}_{x}}^{T} ( 45 ° - α ) {{R}_{y}}^{T} ( θ ) = [ \begin{matrix}{cos}^{2} θ - sin 2 {αsin}^{2} θ & cos 2 αsinθ & - \frac{sin 2 θ ( sin 2 α + 1 )}{2} \\ cos 2 αsinθ & sin 2 α & cos 2 αcosθ \\ - \frac{sin 2 θ ( sin 2 α + 1 )}{2} & cos 2 αcosθ & {sin}^{2} θ - sin 2 {αcos}^{2} θ\end{matrix} ]$$

$$where , {M}_{z} = [ \begin{matrix}1 & 0 & 0 \\ 0 & 1 & 0 \\ 0 & 0 & - 1\end{matrix} ] , {R}_{x} ( α ) = [ \begin{matrix}1 & 0 & 0 \\ 0 & cos α & - sin α \\ 0 & sin α & cos α\end{matrix} ] , \\ {R}_{y} ( θ ) = [ \begin{matrix}cos ( θ ) & 0 & sin ( θ ) \\ 0 & 1 & 0 \\ - sin θ & 0 & cos ( θ )\end{matrix} ] .$$

Similarly, the matrix of Galvo Mirror 2 (GM2) (e.g., the second mirror galvanometer 108) can be defined as:

$${GM}_{2} = {R}_{y} ( - θ ) {R}_{x} ( - 45 ° + α ) {M}_{z} {{R}_{x}}^{T} ( - 45 ° + α ) {{R}_{y}}^{T} ( - θ ) = [ \begin{matrix}{cos}^{2} θ - sin 2 {αsin}^{2} θ & cos 2 αsinθ & sin 2 θ ( sin 2 α + 1 ) / 2 \\ cos 2 αsinθ & sin 2 α & - cos 2 αcosθ \\ sin 2 θ ( sin 2 α + 1 ) / 2 & - cos 2 αcosθ & {sin}^{2} θ - sin 2 {αcos}^{2} θ\end{matrix} ] .$$

According to the vector law of reflection, the relation between the unit vector (n₁) of the surface normal of Mirror 1 (M1) (e.g., the second static mirror 118), incident ray (k₁) and reflected ray (k₃) is:

$${k}_{3} = {k}_{1} - 2 ( {k}_{1} \cdot {n}_{1} ) {n}_{1}$$

where k₁ and k₃ can be calculated by GM1 and GM2. Hence, the matrix of Mirror 2 is:

$${M}_{1} = I - 2 {n}_{1} \cdot {{n}_{1}}^{T}$$

$$[ \begin{matrix}1 - \frac{2 {cos}^{2} 2 {αsin}^{2} θ}{1 - {cos}^{2} 2 {αcos}^{2} θ} & - \frac{sin 4 αsinθ}{1 - {cos}^{2} 2 {αcos}^{2} θ} & 0 \\ - \frac{sin 4 αsinθ}{1 - {cos}^{2} 2 {αcos}^{2} θ} & 1 - \frac{2 {sin}^{2} 2 α}{1 - {cos}^{2} 2 {αcos}^{2} θ} & 0 \\ 0 & 0 & 1\end{matrix} ] .$$

After a series of reflections, the overall effective mirror matrix can be:

$$M = {GM}_{2} {M}_{1} {GM}_{1} = - [ \begin{matrix}- \frac{\begin{matrix}2 sin 2 α + {cos}^{2} 2 αcos2θ - 2 sin 2 {αcos}^{2} 2 θ + \\ {cos}^{2} 2 {αcos}^{2} 2 θ - 2 {cos}^{2} 2 θ\end{matrix}}{{cos}^{2} 2 αcos2θ + {cos}^{2} 2 α - 2} & 0 & - \frac{\begin{matrix}sin 2 θ ( 2 cos 2 θ - {cos}^{2} 2 αcos2θ - \\ {cos}^{2} 2 α + 2 sin 2 αcos2θ )\end{matrix}}{{cos}^{2} 2 αcos2θ + {cos}^{2} 2 α - 2} \\ 0 & 1 & 0 \\ \frac{\begin{matrix}sin 2 θ ( 2 cos 2 θ - {cos}^{2} 2 αcos2θ - \\ {cos}^{2} 2 α + 2 sin 2 αcos2θ )\end{matrix}}{{cos}^{2} 2 αcos2θ + {cos}^{2} 2 α - 2} & 0 & - \frac{\begin{matrix}2 sin 2 α + {cos}^{2} 2 αcos2θ - 2 sin 2 {αcos}^{2} 2 θ + \\ {cos}^{2} 2 {αcos}^{2} 2 θ - 2 {cos}^{2} 2 θ\end{matrix}}{{cos}^{2} 2 αcos2θ + {cos}^{2} 2 α - 2}\end{matrix} ]$$

M has the same structure with the rotation matrix around the y-axis, which can verify the collinearity of the output images and also shows that the output images will be only rotate around y-axis.

When α=0°, M′ is defined as:

$${M}^{′} = - [ \begin{matrix}cos ( - 2 θ ) & 0 & sin ( - 2 θ ) \\ 0 & 1 & 0 \\ - sin ( - 2 θ ) & 0 & cos ( - 2 θ )\end{matrix} ] .$$

In the M′ matrix, −2θ indicates the image is rotated by −2θ, and the minus sign in front of the matrix means the image is flipped in all axes. In FIG. 4A, the y-axis represents the propagation direction of light, so the flip in y-axis means the output of the propagation direction is inverse. The flip of x- and z-axes simply indicates the output image is flipped on the x-z plane. The −2θ rotation of the image when α=0° can also be confirmed in the Zemax simulation (FIGS. 2 and 3).

The relative rotation angle (γ) between two output images with α=0° and α° is:

$$γ = {sin}^{- 1} ( - \frac{sin 2 θ ( 2 cos 2 θ - {cos}^{2} 2 αcos2θ - {cos}^{2} 2 α + 2 sin 2 αcos2θ )}{{cos}^{2} 2 αcos2θ + {cos}^{2} 2 α - 2} ) + 2 θ .$$

Here, one can get the value for the image rotation angle from 0 to 360 degrees based on the sign in the matrix M.

Turning to FIG. 4B, the relative image rotation angle for different choices of galvo orientation and/or distancing angles θ and different scan angles α of the galvo mirrors is plotted on a relative rotation angle (γ) versus scanning angle (α) graph 406. FIG. 4A illustrates how different choices of the angle θ can affect the range of angle rotations that result from a ±10 degree mirror tilt angle (e.g., α). For instance, with θ being 10 degrees, a range of mirror tilt angles of ±10 degrees results in a range of rotation angles between about 125 degrees and about −125 degrees. In contrast, with θ being 50 degrees, the range of mirror tilt angles of ±10 degrees results in a range of rotation angles between about 35 degrees and about −35 degrees. In other words, the range of rotation angles is generally inversely proportional to the size of the range of rotation angles generated. As one can see at the graph 406, through a judicious choice of parameter, image rotators of the systems 100 and 200 covering a wide range of rotation angles can be created.

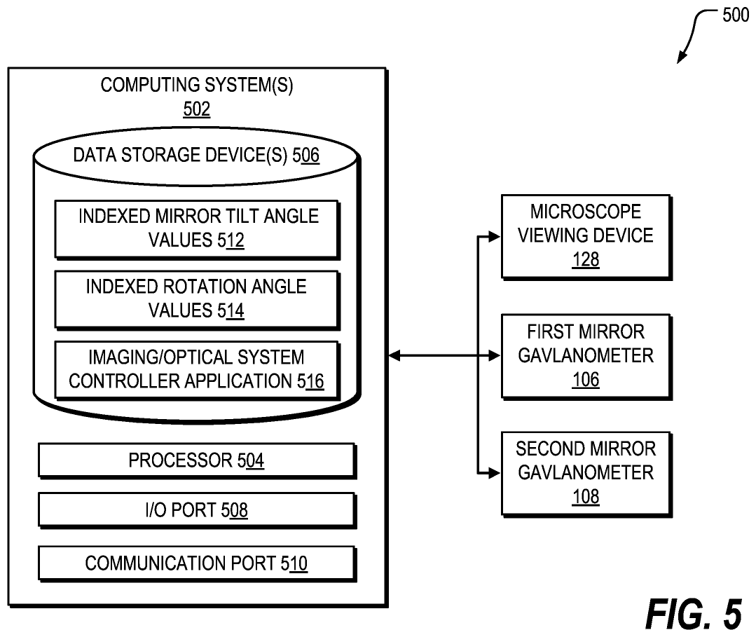

FIG. 5 illustrates an example computing architecture 500 which may form at least a portion of the imaging system(s) 100 and/or the optical system(s) 200 discussed herein. Referring to FIG. 5, the computing architecture 500 can include an example computer system 502 having one or more computing units which may implement the systems and methods discussed herein. It will be appreciated that specific implementations of these devices may be of differing possible specific computing architectures not all of which are specifically discussed herein but will be understood by those of ordinary skill in the art.

In some instances, the computer system(s) 502 may be a computer, a desktop computer, a laptop computer, a cellular or mobile device, a smart mobile device, a wearable device (e.g., a smart watch, smart glasses, a smart epidermal device, etc.) an Internet-of-Things (IoT) device, a smart home device, a virtual reality (VR) or augmented reality (AR) device, combinations thereof, and the like. The computer system 502 can provide operational control over the optical system 100 and/or the optical system 200.

For instance, the computer system 502 may be capable of executing a computer program product to execute a computer process. Data and program files may be input to the computer system 502, which reads the files and executes the programs therein. Some of the elements of the computer system 502 are shown in FIG. 5 and include one or more hardware processors 504, one or more data storage devices 506, one or more I/O ports 508, and/or one or more communication ports 510. Additionally, other elements that will be recognized by those skilled in the art may be included in the computer system 502 but are not explicitly depicted in FIG. 5 or discussed further herein. Various elements of the computer system 502 may communicate with one another by way of one or more communication buses, point-to-point communication paths, or other communication means.

The processor 504 may include, for example, a central processing unit (CPU), a microprocessor, a microcontroller, a digital signal processor (DSP), and/or one or more internal levels of cache. There may be one or more processors 504, such that the processor 504 comprises a single central-processing unit, or a plurality of processing units capable of executing instructions and performing operations in parallel with each other, commonly referred to as a parallel processing environment.

The computer system 502 may be a conventional computer, a distributed computer, or any other type of computer, such as one or more external computers made available via a cloud computing architecture. The presently described technology is optionally implemented in software stored on the data storage device(s) 506 and/or communicated via the one or more of the I/O port(s) 508 and/or communication port(s) 510, thereby transforming the computer system 502 in FIG. 5 to a special purpose machine for implementing the optical system 200 and/or the optical system 100.

The one or more data storage device(s) 506 may include any non-volatile data storage device capable of storing data generated or employed within the computer system 502, such as computer-executable instructions for performing a computer process, which may include instructions of both application programs and an operating system (OS) that manages the various components of the computer system 502. The data storage device(s) 506 may include, without limitation, magnetic disk drives, optical disk drives, solid state drives (SSDs), flash drives, and the like. The data storage devices 506 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The data storage device(s) 506 may include volatile memory (e.g., dynamic random-access memory (DRAM), static random access memory (SRAM), etc.) and/or non-volatile memory (e.g., read-only memory (ROM), flash memory, etc.). The data storage device may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

Computer program products containing mechanisms to effectuate the systems and methods in accordance with the presently described technology may reside in the data storage device(s) 506, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. The machine-readable media may store instructions that, when executed by the processor, cause the systems to perform the operations disclosed herein.

In some examples, one or more indexed mirror tilt values 512 can be stored in the data storage device(s) 506. The computer system 502 can retrieve or access one or more indexed mirror tilt values 512 from the data storage device(s) 506 to move the first mirror galvanometer 106 and the second mirror galvanometer 108 between different indexed mirror tilt values. Additionally or alternatively, the data storage device(s) 506 can store one or more indexed rotation angle values 514, which can be accessed for generating the rotated beam of light 104. For instance, an indexed rotation angle value 514 may correspond to a particular voltage or current that, when sent to the first mirror galvanometer 106 and second mirror galvanometer 108, creates the rotation angle corresponding to the indexed rotation angle value 514. The computer system 502 can store an imaging and/or optical system controller application 516 for receiving various inputs, accessing the one or more indexed mirror tilt values 512 and/or indexed rotation angle value 514, and generating the output signals to the first mirror galvanometer 106, the second mirror galvanometer 108 and/or the microscope viewing device 128 based on the one or more indexed mirror tilt values 512 and/or the indexed rotation angle value 514.

In some implementations, the computer system 502 includes one or more ports, such as the one or more input/output (I/O) port(s) 508 and the one or more communication port(s) 510, for communicating with other computing devices, network devices, the first mirror galvanometer 106, the second mirror galvanometer 108, and/or the microscope viewing device 128. It will be appreciated that the I/O port(s) 508 and the communication port(s) 510 may be combined or separate and that more or fewer ports may be included in the computer system 502.

The I/O port(s) 508 may be connected to an I/O device, or other device, by which information is input to or output from the computer system 502. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computer system 502 via the I/O port 508. Similarly, the output devices may convert electrical signals received from computer system 502 via the I/O port 508 into signals that may be sensed as output by a human, such as sound, light, and/or touch. The input device may be an alphanumeric input device, including alphanumeric and other keys for communicating information and/or command selections to the processor 504 via the I/O port 508. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”) with a graphical user interface (GUI). The output devices may include, without limitation, a display, a touchscreen, a projector, a speaker, a tactile and/or haptic output device, and/or the like. In some implementations, the input device and the output device may be the same device, for example, in the case of a touchscreen.

In one implementation, a communication port 510 is connected to the various components of the optical system 100 and the optical system 200, such as the first mirror galvanometer 106, the second mirror galvanometer 108, and the microscope viewing device 128. The communication port 510 can connect through over a local area network (LAN), a wide area network (WAN) (e.g., the Internet), one or more scientific equipment application programming interface (API) connections or other communication protocols. The communication port 510 can provide various other types of connections, such as for a Universal Serial Bus (USB), Ethernet, Wi-Fi, Bluetooth®, Near Field Communication (NFC), a cellular network (e.g., a Third Generation Partnership Program (3GPP) network), and the like. Further, the communication port 510 may communicate with an antenna or other link for electromagnetic signal transmission and/or reception.

In an example implementation, operations performed by the systems discussed herein may be embodied by instructions stored on the data storage devices 506 and executed by the processor 504, for instance, using the optical system controller application 516. The computer system 502 set forth in FIG. 5 is but one possible example of a computer system that may be employed or configured in accordance with aspects of the present disclosure. It will be appreciated that other non-transitory tangible computer-readable storage media storing computer-executable instructions for implementing the presently disclosed technology on a computing system may be utilized. The methods disclosed herein, such as method 600 regarding FIG. 5, may be implemented as sets of instructions or software readable by the computer system 502.

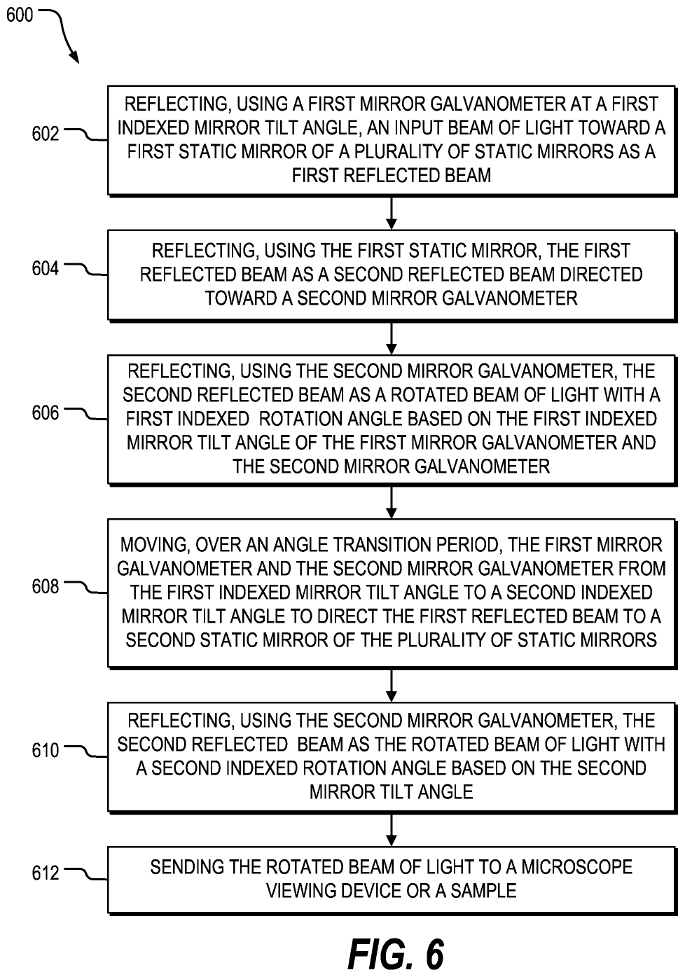

FIG. 6 illustrates a flow chart of an example method 600 for rotating a beam of light which can be performed by the optical systems 100, 200, and/or the computing architecture 500 disclosed herein. At operation 602, the method 600 reflects, using a first galvanometer at a first indexed mirror tilt angle, an input beam of light toward a first static mirror of a plurality of static mirrors as a first reflected beam. At operation 604, the method 600 reflects, using the first static mirror, the first reflected beam as a second reflected beam directed toward a second mirror galvanometer. At operation 606, the method 600 reflects, using the second mirror galvanometer, the second reflected beam as a rotated beam of light with a first indexed operation angle based on the first indexed mirror tilt angle of the first mirror galvanometer and the second mirror galvanometer. At operation 608, the method 600 moves, over an angle transition period, the first mirror galvanometer and the second mirror galvanometer from the first indexed mirror tilt angle to a second indexed mirror tilt angle to direct the first reflected beam to a second static mirror of the plurality of static mirrors. At operation 610, the method 600 reflects, using the second mirror galvanometer, the second reflected beam as the rotated beam of light with a second indexed rotation angle based on the second mirror tilt angle. At operation 612, the method 600 sends the rotated beam of light to a microscope viewing device or a sample.

It is to be understood that the specific order or hierarchy of steps in the method depicted in FIG. 6 (and other methods disclosed herein) are instances of example approaches and can be rearranged while remaining within the disclosed subject matter. For instance, any of the operations depicted in FIG. 6 can be omitted, repeated, performed in parallel, performed in a different order, and/or combined with any other of the operations depicted in FIG. 6. Moreover, any of the systems or methods illustrated in FIGS. 1-6 can be combined together and/or form at least a portion of the optical system 100.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method to rotate a beam of light, the method comprising:
reflecting an input beam of light at a first reflection angle using a first mirror galvanometer, the first reflection angle determined by a mirror tilt angle of the first mirror galvanometer, the first mirror galvanometer directing the input beam of light to a static mirror of a plurality of static mirrors as a first reflected beam;
reflecting the first reflected beam with the static mirror to direct the first reflected beam to a second mirror galvanometer as a second reflected beam; and
reflecting the second reflected beam at a second reflection angle using the second mirror galvanometer, the second reflection angle determined by the mirror tilt angle of the second mirror galvanometer, the second mirror galvanometer forming a rotated beam of light having a rotation angle, relative to the input beam of light, corresponding to the mirror tilt angle.

2. The method of claim 1,
wherein,
the static mirror is a first static mirror of the plurality of static mirrors;
the mirror tilt angle is a first mirror tilt angle;
the rotation angle is a first rotation angle; and
the method further includes:
moving the first mirror galvanometer and the second mirror galvanometer to a second mirror tilt angle;
directing the first reflected beam from the first mirror galvanometer to a second static mirror of the plurality of static mirrors; and
directing the second reflected beam from the second static mirror to the second mirror galvanometer, the rotated beam of light having a second rotation angle, relative to the input beam of light, corresponding to the second mirror tilt angle.

3. The method of claim 2,
wherein,
the second static mirror is positioned above the first static mirror; and
the method further includes:
moving the first mirror galvanometer and the second mirror galvanometer to a third mirror tilt angle;
directing the first reflected beam from the first mirror galvanometer to a third static mirror of the plurality of static mirrors, the third static mirror positioned below the first static mirror; and
directing the second reflected beam from the third static mirror to the second mirror galvanometer, the rotated beam of light having a third rotation angle, relative to the input beam of light, corresponding to the third mirror tilt angle, the third rotation angle being an inverse of the second rotation angle.

4. The method of claim 3,
wherein,
moving the first mirror galvanometer and the second mirror galvanometer to the second mirror tilt angle or the third mirror tilt angle includes an angle transition period of between 1 millisecond and 50 milliseconds.

5. The method of claim 4,
wherein,
the first mirror galvanometer, the second mirror galvanometer, and the first static mirror are in a mirror galvanometer plane.

6. The method of claim 5,
wherein,
the first static mirror is positioned parallel to a y-z plane.

7. The method of claim 6,
wherein,
the second static mirror and the third static mirror are positioned outside the mirror galvanometer plane.

8. The method of claim 1, further comprising:
directing the input beam of light from a light source to the first mirror galvanometer using a static image input mirror; and
directing the rotated beam of light from the second mirror galvanometer to a microscope viewing device using a static image output mirror.

9. The method of claim 8,
wherein,
the light source is a light sheet fluorescence image, a structured illumination microscopy image, or an illumination light for light-sheet fluorescence or structured illumination microscopy.

10. The method of claim 1,
wherein,
the mirror tilt angle is selectable between a plurality of indexed mirror tilt angles causing the rotation angle to be selectable between a plurality of indexed rotation angles.

11. The method of claim 10,
wherein,
the plurality of indexed mirror tilt angles include:
a neutral angle;
a positive angle relative to the neutral angle; and
a negative angle relative to the neutral angle.

12. The method of claim 11,
wherein,
the rotation angle is based on:
a counter-clockwise rotation corresponding to the positive angle; or
a clockwise rotation corresponding to the negative angle.

13. The method of claim 10,
wherein,
the plurality of indexed rotation angles include a 45-degree angle, a 60-degree angle, a 120-degree angle, and a 180-degree angle.

14. An imaging system for rotating a beam of light, the imaging system comprising:
a first mirror galvanometer positioned to reflect an input image beam at a plurality of first indexed reflection angles determined by a mirror tilt angle of the first mirror galvanometer as a first reflected image beam;
a plurality of static mirrors positioned to reflect the first reflected image beam, as a second reflected image beam, at different reflection angles corresponding to the plurality of first indexed reflection angles; and
a second mirror galvanometer positioned to reflect the second reflected image beam at a plurality of second indexed reflection angles determined by the mirror tilt angle of the second mirror galvanometer, the second mirror galvanometer forming a rotated image beam having a rotation angle, relative to the input image beam, corresponding to the mirror tilt angle.

15. The imaging system of claim 14,
wherein,
the plurality of static mirrors are positioned between the first mirror galvanometer and the second mirror galvanometer along an x-axis; and
the plurality of static mirrors are positioned spaced a distance apart from the first mirror galvanometer and the second mirror galvanometer along a z-axis.

16. The imaging system of claim 14,
wherein,
the plurality of static mirrors include:
a first static mirror positioned at a mirror galvanometer plane;
a second static mirror positioned above the mirror galvanometer plane; and
a third static mirror is positioned below the mirror galvanometer plane.

17. The imaging system of claim 14,
wherein,
the mirror tilt angle is a first mirror tilt angle; and
the imaging system includes a memory device storing instructions that, when executed by a processor, cause the imaging system to:
move the first mirror galvanometer and the second mirror galvanometer from the first mirror tilt angle to a second mirror tilt angle such that the first reflected image beam is shifted from reflecting off a first static mirror of the plurality of static mirrors to a reflecting off a second static mirror of the plurality of static mirrors.

18. The imaging system of claim 17, wherein the instructions, when executed by the processor, cause the imaging system to move the first mirror galvanometer and the second mirror galvanometer from the first mirror tilt angle to the second mirror tilt angle in an angle transition period in a range of between 1 and 50 milliseconds.

19. A method to rotate a beam of light, the method comprising:
reflecting an input image beam at a first indexed reflection angle of a plurality of indexed reflection angles using a first mirror galvanometer, the plurality of indexed reflection angles determined by a mirror tilt angle of the first mirror galvanometer, the first mirror galvanometer directing the input image beam to a static mirror of a plurality of static mirrors as a first reflected image beam;
reflecting the first reflected image beam with the static mirror to direct the first reflected image beam to a second mirror galvanometer as a second reflected image beam; and
reflecting the second reflected image beam at a second indexed reflection angle of a the plurality of indexed reflection angles using the second mirror galvanometer, the second indexed reflection angle determined by the mirror tilt angle of the second mirror galvanometer, the second mirror galvanometer forming a rotated image beam having a rotation angle, relative to the input image beam, corresponding to the mirror tilt angle.

20. The method of claim 19,
wherein,
the plurality of indexed reflection angles correspond to a plurality of indexed rotation angles of the rotated image beam.
